(19) United States
(12) Patent Application Publication
(10) Pub. No.: US 2022/0359112 A1
(43) Pub. Date: Nov. 10, 2022

(54) SOLENOID DEVICE AND STARTER

(71) Applicant: Mitsubishi Electric Corporation, Tokyo (JP)

(72) Inventors: Takuma ONO, Tokyo (JP); Koichiro KAMEI, Tokyo (JP)

(73) Assignee: Mitsubishi Electric Corporation, Tokyo (JP)

(21) Appl. No.: 17/619,956

(22) PCT Filed: Oct. 30, 2019
(86) PCT No.: PCT/JP2019/042507

§ 371 Date: Dec. 16, 2021

(51) Int. Cl. H01F 7/08; H01F 27/29; H01F 27/32; F02N 11/08

(52) U.S. Cl. CPC H01F 7/081; H01F 27/29; H01F 27/325; F02N 11/087

(57) ABSTRACT

There is provided a solenoid device in which a fixed wall and a supporting wall having a protruding portion are provided in a flange portion of a bobbin, in which a surge absorption device is held in a space between the supporting wall and the fixed wall, and in which the protruding portion presses the surge absorption device; furthermore, a starter having the solenoid device is provided.

### TECHNICAL FIELD

The present disclosure relates to a solenoid device and a starter.

### BACKGROUND ART

As is well known, in the case of a relay device that is connected with an inductive load such as a coil and supplies a current to the inductive load, a rapid and abrupt current change at a time of a current cutoff may cause a large surge voltage to be generated at the contact portion of the relay device and hence the contact portion of the relay device may be broken. Accordingly, for example, a solenoid device of a starter for starting an engine mounted in a vehicle such as an automobile generally has a configuration in which a surge absorption device for suppressing the foregoing surge voltage from being generated is connected between the both terminals of the coil.

Patent Document 1 discloses an electromagnetic relay having a solenoid device. The solenoid device in the electromagnetic relay disclosed in Patent Document 1 is configured in such a way that a mounting wall of a terminal mounting portion is erectly provided on a flange portion of a resin bobbin around which a coil is wound, that respective terminal holding portions for holding a pair of coil terminals are provided at both the left and right sides of the mounting wall, that an intermediate terminal holding portion for holding an intermediate terminal is provided in the center of the mounting wall, that the pair of coil terminals are held in the respective terminal holding portions at the left and right sides, that the intermediate terminal is held in the intermediate terminal holding portion, and that each of a pair of surge absorption devices is disposed between the intermediate terminal and each corresponding one of the pair of coil terminals.

The conventional solenoid device in the electromagnetic relay disclosed in Patent Document 1 is configured in such a way that as the surge absorption device, a package of an axial-type surge absorption device connected with a lead wire is utilized and that the package of the surge absorption device is electrically connected with the coil terminal by means of welding or the like.

### PRIOR ART REFERENCE

### Patent Document

[Patent Document 1] National Publication of International Patent Application No. 2007-207495

### DISCLOSURE OF THE INVENTION

### Problems to be Solved by the Invention

In general, an axial-type surge absorption device is rather large; thus, in order to connect the surge absorption device with a pair of coil terminals through welding on a bobbin around which a coil is wound, it is required to secure a rather large welding space. Accordingly, because it is required that as described above, a rather large welding space for connecting the surge absorption device with the coil terminals through welding is secured, there has been a problem that the conventional solenoid device disclosed in Patent Document 1 is upsized.

Moreover, because an engine-starting starter provided with the conventional solenoid device utilizes a solenoid device for which as described above, it is required that a rather large welding space for connecting the surge absorption device with the coil terminals through welding is secured, there has been a problem that the starter is upsized.

The present disclosure is to disclose a technology for solving the foregoing problems; the objective thereof is to provide a solenoid device that realizes downsizing.

In addition, the objective of the present disclosure is to provide a starter that realizes downsizing.

### Means for Solving the Problems

A solenoid device disclosed in the present disclosure includes
a bobbin having a flange portion in at least one of end portions thereof in an axial direction of a coil winding portion,
a coil being wound around the coil winding portion and having a first coil terminal and a second coil terminal that are each pulled out from the flange portion to the outside of the bobbin,
a positive electrode terminal fixed to the flange portion and electrically connected with the first coil terminal, and
a negative electrode terminal fixed to the flange portion and electrically connected with the second coil terminal; a first terminal of a surge absorption device can be electrically connected with the positive electrode terminal and a second terminal of the surge absorption device can be electrically connected with the negative electrode terminal. The solenoid device is characterized

in that there are further included
a fixed wall provided at an axis-direction endface of the flange portion,
a supporting wall provided at the axis-direction endface of the flange portion and facing the fixed wall via a space, and
a protruding portion provided in at least one of the supporting wall and the fixed wall and protruding into the space,

in that the fixed wall and the supporting wall can hold the surge absorption device at least part of which is disposed in the space, and

in that based on elastic force of the supporting wall, the protruding portion can apply pressing force to the held surge absorption device toward the endface of the flange portion.

A starter disclosed in the present disclosure includes
a relay device that is driven by an engine starting signal so as to close a relay contact,
a solenoid device that has a coil to be energized by way of the relay contact when the relay device is driven and a solenoid switch that closes when the coil is energized,
a surge absorption device that absorbs a surge voltage generated in the coil, and
a motor that is driven so as to start an engine, when the solenoid switch closes. As the foregoing solenoid device, the solenoid device according to any one of claims 1 through 7 is utilized.

Advantage of the Invention

The present disclosure makes it possible to obtain a solenoid device that realizes downsizing.

The present disclosure makes it possible to obtain a starter that realizes downsizing.

### BRIEF DESCRIPTION OF THE DRAWINGS

FIG. 1 is a circuit diagram of an engine-starting starter provided with a solenoid device according to Embodiment 1;

FIG. 2 is a perspective view illustrating part of the solenoid device according to Embodiment 1;

FIG. 3A is an explanatory view illustrating a procedure for mounting a surge absorption device to a bobbin in the solenoid device according to Embodiment 1;

FIG. 3B is an explanatory view illustrating the procedure for mounting the surge absorption device to the bobbin in the solenoid device according to Embodiment 1;

FIG. 4 is a side view illustrating the state where the surge absorption device has been mounted to the bobbin in the solenoid device according to Embodiment 1;

FIG. 5 is a top view illustrating the state where the surge absorption device has been mounted to the bobbin in the solenoid device according to Embodiment 1;

FIG. 6 is a perspective view illustrating another example of the electric connection between the surge absorption device and respective connection terminal portions in the solenoid device according to Embodiment 1;

FIG. 7 is a top view illustrating electric connection between a surge absorption device and respective connection terminal portions in a solenoid device according to Embodiment 2;

FIG. 8 is a perspective view illustrating the connection terminal portion in the solenoid device according to Embodiment 2;

FIG. 9 is a top view illustrating electric connection between a surge absorption device and respective connection terminal portions in a solenoid device according to Embodiment 3; and

FIG. 10 is a perspective view illustrating the connection terminal portion in the solenoid device according to Embodiment 3.

### BEST MODE FOR CARRYING OUT THE INVENTION

Each of respective solenoid devices according to after-mentioned embodiments will be explained for the case where it is utilized as a solenoid device of a starter to be mounted in a vehicle such as an automobile; however, the present disclosure is not limited thereto.

### Embodiment 1

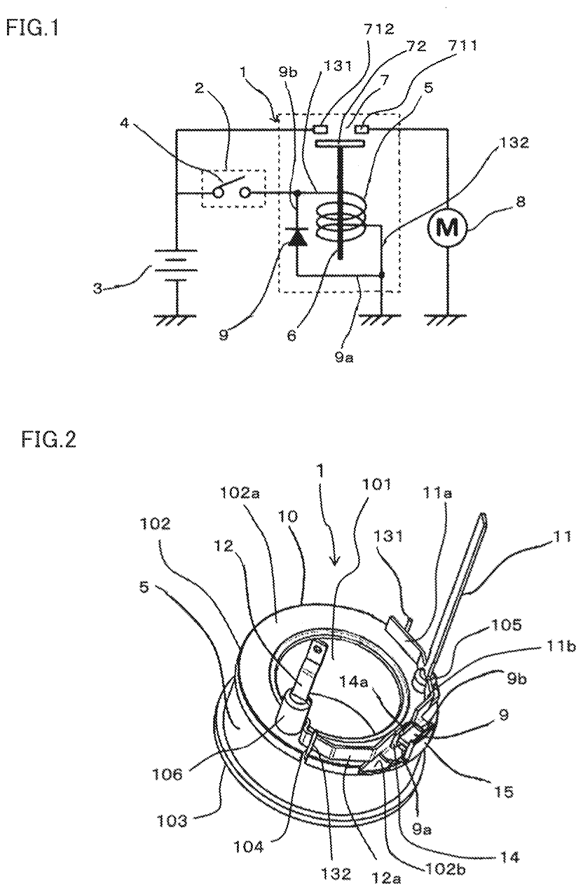

FIG. 1 is a circuit diagram of an engine-starting starter provided with a solenoid device according to Embodiment 1. A solenoid device 1 is electrically connected with a battery 3 by way of a relay device 2. The solenoid device 1 has a coil 5, a plunger 6 to be driven by the coil 5, a solenoid switch 7, a diode 9 as a surge absorption device, and an after-mentioned bobbin 10 around which the coil 5 is wound and that is formed of a synthetic resin or the like.

The solenoid switch 7 has a first fixed contact 711 connected with a motor 8, a second fixed contact 712 connected with the positive electrode of the battery 3, and a movable contact 72 that makes contact with or departs from the first fixed contact 711 and the second fixed contact 712. A first coil terminal 131 of the coil 5 is connected with the positive electrode of the battery 3 by way of the relay device 2; a second coil terminal 132 thereof is connected with a ground potential portion. An anode terminal 9a of the diode 9 as a surge absorption device is connected with the second coil terminal 132; a cathode terminal 9b thereof is connected with the first coil terminal 131.

In the starter configured in such a manner as described above, when the relay device 2 is driven by an engine starting signal, a relay contact 4 closes; then, the battery 3 supplies a current to the coil 5 of the solenoid device 1, so that a magnetic field is generated in the coil 5. The magnetic field generated in the coil 5 drives the plunger 6; the movable contact 72 of the solenoid switch 7 that moves in conjunction with an action of the plunger 6 makes contact with the first fixed contact 711 and the second fixed contact 712, so that the solenoid switch 7 closes.

When the solenoid switch 7 closes, the battery 3 supplies a current to the motor 8; then, the starter operates to start an engine. When the engine has been started, the relay contact 4 opens and cuts off the current flowing in the coil 5. In this situation, because a surge voltage generated in the coil 5 is absorbed by the diode 9 as a surge absorption device, the relay contact 4 of the relay device 2 is protected from the surge voltage.

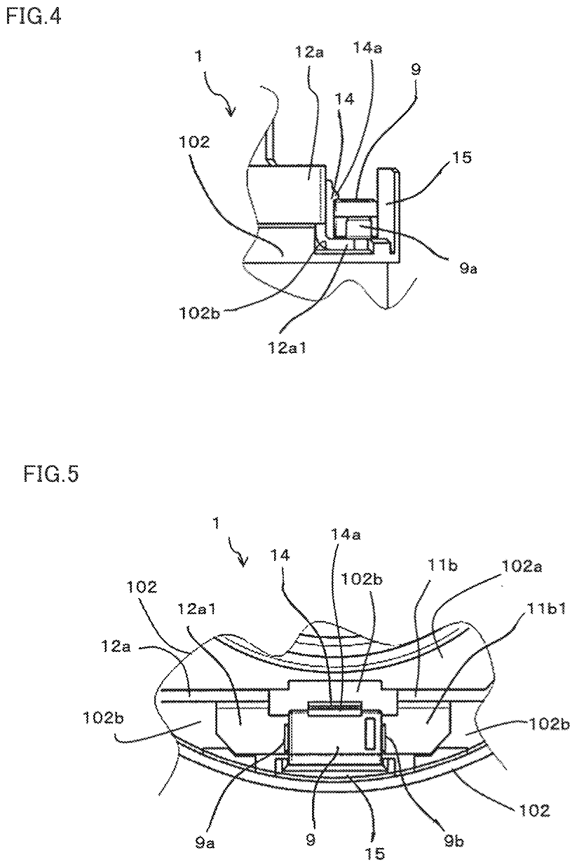

Next, the configuration of the solenoid device 1 will be explained. FIG. 2 is a perspective view illustrating part of the solenoid device according to Embodiment 1; FIG. 4 is a side view illustrating the state where the surge absorption device has been mounted to the bobbin in the solenoid device according to Embodiment 1; FIG. 5 is a top view illustrating the state where the surge absorption device has been mounted to the bobbin in the solenoid device according to Embodiment 1.

In FIGS. 2, 4, and 5, the bobbin 10 made of a synthetic resin has a coil winding portion 101 formed in the shape of a cylindrical tube having a penetration hole in the central portion thereof, a first flange portion 102 provided at one axis-direction end portion of the coil winding portion 101, and a second flange portion 103 provided at the other axis-direction end portion of the coil winding portion 101. Two notched portions 104 (in FIG. 2, only one of the notched portions 104 is illustrated) for pulling out the first coil terminal 131 and the second coil terminal 132 to the outside of the bobbin 10 are provided in the first flange portion 102.

The coil 5 is introduced to the outer circumferential surface of the coil winding portion 101 through one of the notched portions 104 in the first flange portion 102 and is wound around the outer circumferential surface of the coil winding portion 101; then, the coil 5 is pulled out to the outside of the bobbin 10 through the other one of the notched portions 104. The respective electric conductors of the coil 5 pulled out through the two notched portions 104 form the first coil terminal 131 and the second coil terminal 132, described above.

The axis-direction end portion of the first flange portion 102 has a ring-shaped flat portion 102a perpendicular to the axial direction of the bobbin 10 and a cut-down surface portion 102b that has been cut down from the flat portion 102a toward the coil 5 in the axial direction of the bobbin 10. The cut-down surface portion 102b is formed by cutting down part of periphery of the outer circumferential portion of the ring-shaped flat portion 102a.

One end portion of a supporting wall 14 is fixed to the cut-down surface portion 102b of the first flange portion 102; the supporting wall 14 erects from the cut-down surface portion 102b in the axial direction of the bobbin 10 and has a protruding portion 14a, at the periphery of the free end thereof, that protrudes toward the radially outside of the first flange portion 102. The protruding portion 14a is provided on the wall surface, facing a fixed wall 15, of the supporting wall 14 in such a way as to extend in parallel with the surface of the cut-down surface portion 102b. The supporting wall 14 is formed of a material having elasticity, for example, a synthetic resin having elasticity.

The fixed wall 15 is provided in such a way that one end portion thereof is fixed to the outer circumferential portion of the cut-down surface portion 102b of the first flange portion 102 and in such a way as to erect in the axial direction of the bobbin 10. The fixed wall 15 faces the supporting wall 14 and the protruding portion 14a of the supporting wall 14 via a space. The protruding portion 14a is provided in such a way as to protrude into the space formed by the supporting wall 14 and the fixed wall 15.

It may be allowed that the supporting wall 14 and the fixed wall 15 are formed integrally with the first flange portion 102 by use of a material the same as that of the first flange portion 102 or that the supporting wall 14 and the fixed wall 15, formed separately from the first flange portion 102, are provided in the first flange portion 102 in such a manner as described above.

A first protruding portion 105 for holding a positive electrode terminal 11 and a second protruding portion 106 for holding a negative electrode terminal 12 are provided in the flat portion 102a of the first flange portion 102. The first protruding portion 105 and the second protruding portion 106 are each provided in such a way as to protrude from the flat portion 102a of the first flange portion 102 in the axial direction of the bobbin 10 and are arranged in such a way as to face each other via the penetration hole in the bobbin 10. The first protruding portion 105 and the second protruding portion 106 are each formed integrally with the first flange portion 102. In addition, it may be allowed that the first protruding portion 105 and the second protruding portion 106, formed separately from the first flange portion 102, are each provided in the flat portion 102a of the first flange portion 102 in such a manner as described above.

The positive electrode terminal 11 is inserted into the first protruding portion 105 in the axial direction of the bobbin 10 and is fixed to the flat portion 102a of the first flange portion 102 through the intermediary of the first protruding portion 105. The negative electrode terminal 12 is inserted into the second protruding portion 106 in the axial direction of the bobbin 10 and is fixed to the flat portion 102a of the first flange portion 102 through the intermediary of the second protruding portion 106.

The positive electrode terminal 11 has a first extending portion 11a and a second extending portion 11b that each extend from the base portion thereof inserted into the first protruding portion 105, along the flat portion 102a of the first flange portion 102. The first extending portion 11a and the second extending portion 11b are extended out in such a way as to extend in respective directions opposite to each other.

Each of the first extending portion 11a and the second extending portion 11b is pulled out through a notched portion provided in the first protruding portion 105 to the outside of the first protruding portion 105. The first extending portion 11a of the positive electrode terminal 11 is electrically connected with the first coil terminal 131 through welding, brazing, or the like. As well illustrated in FIG. 5, the second extending portion 11b of the positive electrode terminal 11 has a first connection terminal portion llbl that is disposed in such away as to be bent from the second extending portion 11b toward the radially outside of the first flange portion 102 and in such a way that the rear side thereof faces the cut-down surface portion 102b. The rear side of the first connection terminal portion 11b1 abuts on the surface of the cut-down surface portion 102b of the first flange portion 102.

The negative electrode terminal 12 has an extending portion 12a that extends from the base portion thereof inserted into the second protruding portion 106, along the flat portion 102a of the first flange portion 102. The extending portion 12a of the negative electrode terminal 12 is pulled out through a notched portion provided in the second protruding portion 106 to the outside of the second protruding portion 106. The extending portion 12a of the negative electrode terminal 12 is electrically connected with the second coil terminal 132 through welding, brazing, or the like. As well illustrated in FIGS. 4 and 5, the extending portion 12a of the negative electrode terminal 12 has a second connection terminal portion 12a1 that is disposed in such a way as to be bent from the extending portion 12a of the negative electrode terminal 12 toward the radially outside of the first flange portion 102 and in such a way that the rear side thereof faces the cut-down surface portion 102b. The rear side of the second connection terminal portion 12a1 abuts on the surface of the cut-down surface portion 102b of the first flange portion 102.

The surface of the first connection terminal portion 11b1 in the second extending portion 11b of the positive electrode terminal 11 and the surface of the second connection terminal portion 12a1 in the extending portion 12a of the negative electrode terminal 12 are arranged in such a way as to face each other via the space formed between the supporting wall 14 and the fixed wall 15.

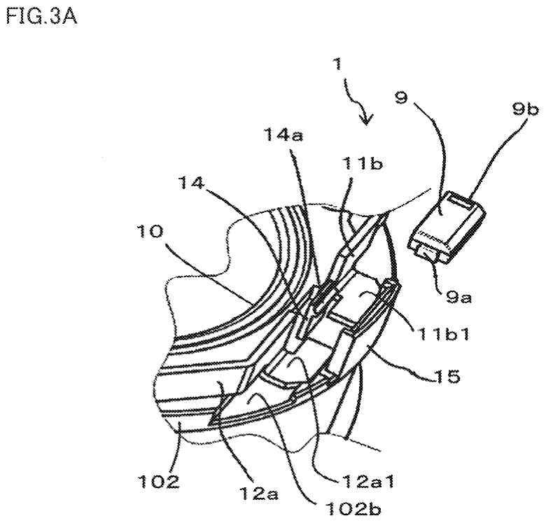

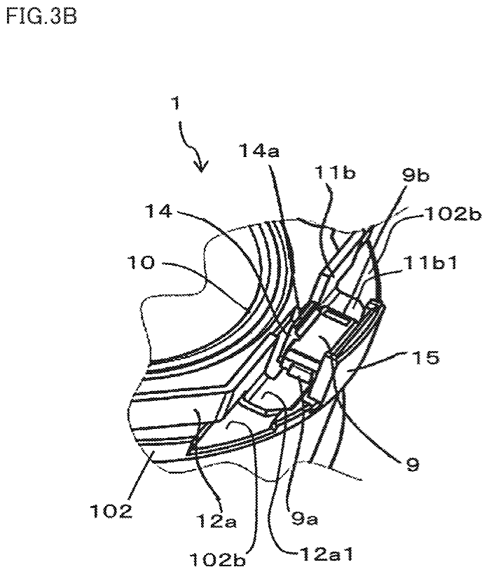

Next, there will be explained a procedure for mounting the diode 9 as a surge absorption device to the bobbin 10 in the solenoid device 1. FIG. 3A is an explanatory view illustrating the procedure for mounting a surge absorption device to the bobbin in the solenoid device according to Embodiment 1; FIG. 3A illustrates the state where the diode 9 as a surge absorption device has not been mounted to the bobbin 10. FIG. 3B is an explanatory view illustrating the procedure for mounting the surge absorption device to the bobbin in the solenoid device according to Embodiment 1; FIG. 3B illustrates the state where the diode 9 as a surge absorption device has been mounted to the bobbin 10.

As illustrated in FIG. 3A, as the diode 9 as a surge absorption device, a surface-mounting diode for board mounting or the like is utilized. This diode 9 is configured, for example, as a rather thin package whose front side and rear side are each formed in the shape of a rectangle; an anode terminal 9a as a second terminal of the diode 9 and a cathode terminal 9b as a first terminal of the diode 9 are provided in an exposed manner in the respective side-surface portions at the short sides facing each other.

As illustrated in FIG. 3A, before the diode 9 is mounted to the bobbin 10, the first connection terminal portion 11b1 of the positive electrode terminal 11 and the second connection terminal portion 12a1 of the negative electrode terminal 12 are exposed to the space between the fixed wall 15 and the supporting wall 14 that are provided in the bobbin 10. In order to mount the diode 9 being in the state illustrated in FIG. 3A to the bobbin 10, a pair of long sides, facing each other, of the diode 9 are made to correspond to the respective wall surfaces, facing each other, of the fixed wall 15 and the supporting wall 14, in such a way as to become parallel thereto; then, from the upper end portions of the fixed wall 15 and the supporting wall 14, the diode 9 is pressed toward the first flange portion 102 in the axial direction of the bobbin 10.

Because when the diode 9 passes the protruding portion 14a provided in the supporting wall 14, the side surface of the diode 9 presses the protruding portion 14a toward the radially inside of the first flange portion 102, the supporting wall 14 having elasticity is warped toward the radially inside of the first flange portion 102; however, after the diose 9 has passed the protruding portion 14a, the supporting wall 14 having elasticity is restored to the original position. After passing the protruding portion 14a, the diode 9 is placed on the surface of the first connection terminal portion llbl of the positive electrode terminal 11 and the surface of the second connection terminal portion 12a1 of the negative electrode terminal 12, as illustrated in FIG. 3B.

In the state illustrated in FIG. 3B, the diode 9 is held in the space between the fixed wall 15 and the supporting wall 14; the cathode terminal 9b of the diode 9 is electrically connected with the first connection terminal portion 11b1 of the positive electrode terminal 11, and the anode terminal 9a of the diode 9 is electrically connected with the second connection terminal portion 12a1 of the negative electrode terminal 12. The height, from the cut-down surface portion 102b, of the position at which the protruding portion 14a is provided in the supporting wall 14 is set to the one with which it is made possible that a contact pressure is provided between the cathode terminal 9b of the diode 9 and the first connection terminal portion 11b1 and maintains the electric connection therebetween and that a contact pressure is provided between the anode terminal 9a of the diode 9 and the second connection terminal portion 12a1 and maintains the electric connection therebetween.

In FIG. 3B, based on the elastic force of the supporting wall 14, the protruding portion 14a provided in the supporting wall 14 presses the diode 9 as a surge absorption device toward the endface of the first flange portion 102, i.e., toward the cut-down surface portion 102b.

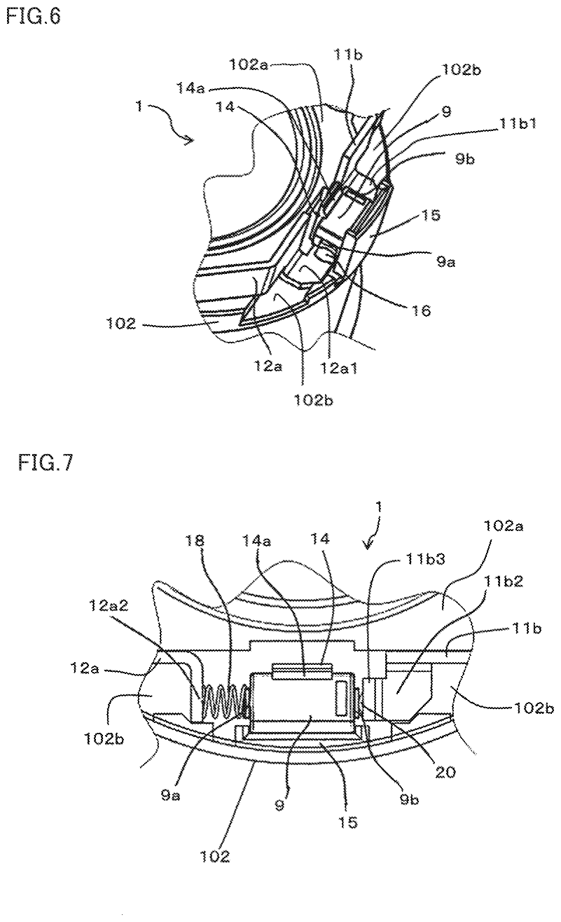

FIG. 6 is a perspective view illustrating another example of the electric connection between the diode and the respective connection terminal portions in the solenoid device according to Embodiment 1. In the case where a current flowing in the diode 9 is large or in the case where more stable electric connection is required, the anode terminal 9a of the diode 9 is electrically connected with the second connection terminal portion 12a1 of the negative electrode terminal 12 by a soldering portion 16 as a bonding member based on soldering; similarly, the cathode terminal 9b of the diode 9 is electrically connected with the first connection terminal portion 11b1 of the positive electrode terminal 11 by a soldering portion (unillustrated) as a bonding member based on soldering.

In addition, it may be allowed that in the solenoid device according to Embodiment 1, the protruding portion 14a is provided in the wall surface, of the fixed wall 15, that faces the supporting wall 14. Furthermore, it may be allowed that the respective protruding portions 14a are provided in the wall surfaces, of the supporting wall 14 and the fixed wall 15, that face each other.

As described heretofore, in the solenoid device according to Embodiment 1, a rather small surface-mounting surge absorption device is placed on a bobbin; thus, it is made possible to provide a solenoid device that facilitates mounting of the surge absorption device and is downsized.

In addition, the starter according to Embodiment 1 is configured in such a way as to have a coil to be energized by way of a relay device and a solenoid switch for driving a motor that starts an engine, when the coil is energized, and in such a way as to utilize, as a solenoid device, the solenoid device according to Embodiment 1, described above. Embodiment 1 makes it possible to provide a downsized starter.

### Embodiment 2

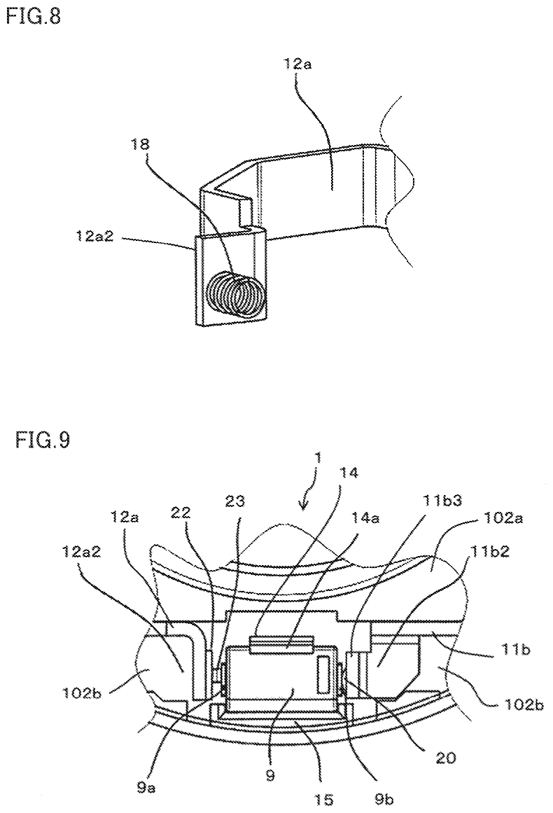

Next, a solenoid device according to Embodiment 2 will be explained. FIG. 7 is a top view illustrating electric connection between a surge absorption device and respective connection terminal portions in a solenoid device according to Embodiment 2; FIG. 8 is a perspective view illustrating the connection terminal portion in the solenoid device according to Embodiment 2. In Embodiment 2, electric connection between a diode as a surge absorption device and a first connection terminal portion in the positive electrode terminal and a second connection terminal portion in the negative electrode terminal is made by use of elastic force of a coil spring. The configurations other than those described below are the same as those of the solenoid device according to Embodiment 1.

In FIGS. 7 and 8, the second extending portion 11b of the positive electrode terminal 11 has a bending portion 11b2 and a first connection terminal portion 11b3. The bending portion 11b2 is bent from the second extending portion 11b of the positive electrode terminal 11 toward the radially outside of the first flange portion 102, and the rear side thereof abuts on the cut-down surface portion 102b. The first connection terminal portion 11b3 is formed in such a way as to be bent from the bending portion 11b2 toward the side opposite to the cut-down surface portion 102b side and to erect in the axial direction of the bobbin 10. A protruding portion 20 is provided in the surface, at the diode 9 side, of the first connection terminal portion 11b3. The protruding portion 20 is formed in such a way as to be hammered out from the first connection terminal portion 11b3 through sheet metal machining or the like.

The extending portion 12a of the negative electrode terminal 12 has a second connection terminal portion 12a2 that is bent toward the radially outside of the first flange portion 102. The surface, at the diode 9 side, of the second connection terminal portion 12a2 faces the surface, at the diode 9 side, of the first connection terminal portion 11b3 and the surface of the protruding portion 20 via the space formed by the supporting wall 14 and the fixed wall 15. One end portion of a coil spring 18 is electrically connected with and fixed to the surface, at the diode 9 side, of the second connection terminal portion 12a2 of the negative electrode terminal 12. The other end of the coil spring 18 is a free end.

In order to mount the diode 9 to the bobbin 10, a pair of long sides, facing each other, of the diode 9 are made to correspond to the respective wall surfaces, facing each other, of the fixed wall 15 and the supporting wall 14, in such a way as to become parallel thereto; then, from the upper end portions of the fixed wall 15 and the supporting wall 14, the diode 9 is pressed toward the first flange portion 102 of the bobbin 10 in the axial direction of the bobbin 10. In this situation, the anode terminal 9a of the diode 9 abuts on the free end of the coil spring 18 while compressing the coil spring 18; the cathode terminal 9b of the diode 9 abuts on the surface of the protruding portion 20 in the first connection terminal portion 11b3 of the positive electrode terminal 11.

Because when the diode 9 passes the protruding portion 14a provided in the supporting wall 14, the side surface of the diode 9 presses the protruding portion 14a toward the radially inside of the first flange portion 102, the supporting wall 14 is warped toward the radially inside of the first flange portion 102; however, after the diose 9 has passed the protruding portion 14a, the supporting wall 14 is restored to the original position due to its elastic force. The diode 9 that has passed the protruding portion 14a is held in the space formed between the fixed wall 15 and the supporting wall 14 restored to the original position. In this situation, based on its elastic force, the protruding portion 14a presses the held diode 9 toward the cut-down surface portion 102b, which is the endface of the first flange portion 102.

In this situation, the anode terminal 9a as the second terminal of the diode 9 is electrically connected with the free end of the coil spring 18 so as to be connected with the negative electrode terminal 12 by way of the coil spring 18 and the second connection terminal portion 12a2. The cathode terminal 9b as the first terminal of the diode 9 is electrically connected with the protruding portion 20 provided in the first connection terminal portion 11b3 so as to be connected with the positive electrode terminal 11 by way of the protruding portion 20 and the first connection terminal portion 11b3.

As explained heretofore, in the solenoid device according to Embodiment 2, electric connection between the diode 9 as a surge absorption device and the connection terminal portions is made by use of the elastic force of the coil spring provided at the connection terminal portion; therefore, it is made possible to provide a solenoid device that facilitates mounting of the surge absorption device and is downsized.

In addition, the starter according to Embodiment 2 is configured in such a way as to have a coil to be energized by way of a relay device and a solenoid switch for driving a motor that starts an engine, when the coil is energized, and in such a way as to utilize, as a solenoid device, the solenoid device according to Embodiment 2, described above. Embodiment 2 makes it possible to provide a downsized starter.

### Embodiment 3

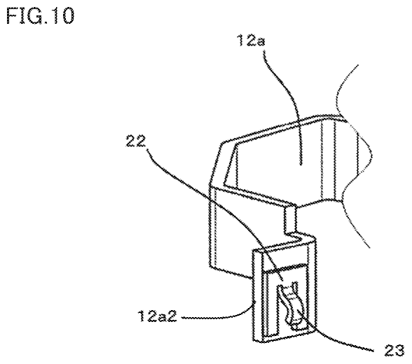

Next, a solenoid device according to Embodiment 3 will be explained. FIG. 9 is a top view illustrating electric connection between a surge absorption device and respective connection terminal portions in a solenoid device according to Embodiment 3; FIG. 10 is a perspective view illustrating the connection terminal portion in the solenoid device according to Embodiment 3. In the solenoid device according to Embodiment 3, electric connection between a diode as a surge absorption device and a first connection terminal portion in the positive electrode terminal and a second connection terminal portion in the negative electrode terminal is made by use of elastic force of a leaf spring portion. The configurations other than those described below are the same as those of the solenoid device according to Embodiment 1.

In FIGS. 9 and 10, the second extending portion 11b of the positive electrode terminal 11 has a bending portion 11b2 and a first connection terminal portion 11b3. The bending portion 11b2 is bent from the second extending portion 11b of the positive electrode terminal 11 toward the radially outside of the first flange portion 102, and the rear side thereof abuts on the cut-down surface portion 102b. The first connection terminal portion 11b3 is bent and erects from the bending portion 11b2 toward the side opposite to the cut-down surface portion 102b side. The protruding portion 20 is provided in the surface, at the diode 9 side, of the first connection terminal portion 11b3. The protruding portion 20 is formed in such a way as to be hammered out from the first connection terminal portion 11b3 through sheet metal machining or the like.

The extending portion 12a of the negative electrode terminal 12 has a second connection terminal portion 12a2 that is bent toward the radially outside of the first flange portion 102. The surface, at the diode 9 side, of the second connection terminal portion 12a2 faces the surface, at the diode 9 side, of the first connection terminal portion 11b3 and the surface of the protruding portion 20 via the space formed between the supporting wall 14 and the fixed wall 15. A terminal 22 is bonded to the surface, at the diode 9 side, of the second connection terminal portion 12a2 of the negative electrode terminal 12 through welding, brazing, or the like, so that the terminal 22 is electrically connected with the second connection terminal portion 12a2. The terminal 22 has a leaf spring portion 23 formed integrally with the terminal 22 through sheet metal machining or the like. The leaf spring portion 23 has elasticity and the free end thereof protrudes toward the diode 9.

In order to mount the diode 9 to the bobbin 10, a pair of long sides, facing each other, of the diode 9 are made to correspond to the respective wall surfaces, facing each other, of the fixed wall 15 and the supporting wall 14, in such a way as to become parallel thereto; then, from the upper end portions of the fixed wall 15 and the supporting wall 14, the diode 9 is pressed toward the first flange portion 102 of the bobbin 10 in the axial direction of the bobbin 10. In this situation, the anode terminal 9a of the diode 9 warps the leaf spring portion 23 toward the second connection terminal portion 12a2, while resting the elastic force thereof, so that the anode terminal 9a abuts on the leaf spring portion 23. Concurrently, the elastic force of the leaf spring portion 23 presses the cathode terminal 9b of the diode 9 so that the cathode terminal 9b makes contact with the protruding portion 20 provided in the first connection terminal portion 11b3 of the positive electrode terminal 11.

Because when the diode 9 passes the protruding portion 14a in the supporting wall 14, the side surface of the diode 9 presses the protruding portion 14a toward the radially inside of the first flange portion 102, the supporting wall 14 is warped toward the radially inside of the first flange portion 102; however, after the diose 9 has passed the protruding portion 14a, the supporting wall 14 is restored to the original position due to its elastic force. After passing the protruding portion 14a, the diode 9 is placed on the surface of the cut-down surface portion 102b of the first flange portion 102 under the condition that the anode terminal 9a is pressed by the leaf spring portion 23 so as to make contact with it and to be electrically connected with it and that the cathode terminal 9b is pressed by the protruding portion 20 in the first connection terminal portion 11b3 of the positive electrode terminal 11 so as to make contact with it and to be electrically connected with it.

The diode 9 that has passed the protruding portion 14a is held in the space formed between the fixed wall 15 and the supporting wall 14 restored to the original position. In this situation, based on its elastic force, the protruding portion 14a presses the held diode 9 toward the cut-down surface portion 102b, which is the endface of the first flange portion 102.

As explained heretofore, in the solenoid device according to Embodiment 3, electric connection between the diode 9 as a surge absorption device and the connection terminal portions is made by use of the elastic force of the leaf spring portion of the terminal provided at the connection terminal portion; therefore, it is made possible to provide a solenoid device that facilitates mounting of the surge absorption device and is downsized.

In addition, the starter according to Embodiment 3 is configured in such a way as to have a coil to be energized by way of a relay device and a solenoid switch for driving a motor that starts an engine, when the coil is energized, and in such a way as to utilize, as a solenoid device, the solenoid device according to Embodiment 3, described above. Embodiment 3 makes it possible to provide a downsized starter.

Each of the respective solenoid devices according to the foregoing embodiments has been explained under the assumption that a surge absorption device for absorbing a surge voltage generated in the coil has already been mounted; however, because the foregoing solenoid device is configured in such a way that a surge absorption device can be mounted therein, it may be allowed that a user mounts a surge absorption device to the solenoid device according to the present disclosure.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, there are included the case where at least one constituent element is modified, added, or omitted and the case where at least one constituent element is extracted and then combined with constituent elements of other embodiments.

### INDUSTRIAL APPLICABILITY

A solenoid device according to the present disclosure can be applied to the field of an electromagnetic relay and further to the field of a vehicle such as an automobile having an engine starter utilizing an electromagnetic relay.

### DESCRIPTION OF REFERENCE NUMERALS

1: solenoid device
2: relay device
3: battery
4: relay contact
5: coil
131: first coil terminal
132: second coil terminal
6: plunger
7: solenoid switch
711: first fixed contact
712: second fixed contact
72: movable contact
8: motor
9: diode
9a: anode terminal
9b: cathode terminal
10: bobbin
101: coil winding portion
102: first flange portion
102a: flat portion
102b: cut-down surface portion
103: second flange portion
104: notched portion
105: first protruding portion
106: second protruding portion
11: positive electrode terminal
11a: first extending portion
11b: second extending portion
11b1, 11b3: first connection terminal portion
12a1, 12a2: second connection terminal portion
11b2: bending portion
12: negative electrode terminal
12a: extending portion
131: first coil terminal
132: second coil terminal
14: supporting wall
14a: protruding portion
15: fixed wall
16: soldering portion
18: coil spring
20: protruding portion
22: terminal
23: leaf spring portion

1-8. (canceled)

9. A solenoid device comprising:
a bobbin having a flange portion in at least one of end portions thereof in an axial direction of a coil winding portion;
a coil being wound around the coil winding portion and having a first coil terminal and a second coil terminal that are each pulled out from the flange portion to the outside of the bobbin;
a positive electrode terminal fixed to the flange portion and electrically connected with the first coil terminal; and
a negative electrode terminal fixed to the flange portion and electrically connected with the second coil terminal,
wherein a first terminal of a surge absorption device can be electrically connected with the positive electrode terminal and a second terminal of the surge absorption device can be electrically connected with the negative electrode terminal,
wherein there are further comprised
a fixed wall provided at an axis-direction endface of the flange portion,
a supporting wall provided at the axis-direction endface of the flange portion and facing the fixed wall via a space, and
a protruding portion provided in at least one of the supporting wall and the fixed wall and protruding into the space,
wherein the fixed wall and the supporting wall can hold the surge absorption device at least part of which is disposed in the space, and
wherein based on elastic force of the supporting wall, the protruding portion can apply pressing force to the held surge absorption device toward the endface of the flange portion.

10. The solenoid device according to claim 9, further comprising a first connection terminal portion provided in the flange portion and electrically connected with the positive electrode terminal and a second connection terminal portion provided in the flange portion and electrically connected with the negative electrode terminal,
wherein the first connection terminal portion can be electrically connected with the first terminal of the held surge absorption device, based on the pressing force, and
wherein the second connection terminal portion can be electrically connected with the second terminal of the held surge absorption device, based on the pressing force.

11. The solenoid device according to claim 9, further comprising a first connection terminal portion provided in the flange portion and electrically connected with the positive electrode terminal and a second connection terminal portion provided in the flange portion and electrically connected with the negative electrode terminal,
wherein the first connection terminal portion can be electrically connected with the first terminal of the held surge absorption device, through a bonding member, and
wherein the second connection terminal portion can be electrically connected with the second terminal of the held surge absorption device, through a bonding member.

12. The solenoid device according to claim 9, further comprising a first connection terminal portion provided in the flange portion and electrically connected with the positive electrode terminal, a second connection terminal portion provided in the flange portion and electrically connected with the negative electrode terminal, and a coil spring electrically connected with at least one of the first connection terminal portion and the second connection terminal portion,
wherein at least one of electric connection between the first connection terminal portion and the first terminal of the surge absorption device and electric connection between the second connection terminal portion and the second terminal of the surge absorption device can be made through the coil spring, and
wherein each of the respective electric connections can be maintained based on elastic force of the coil spring.

13. The solenoid device according to claim 9, further comprising a first connection terminal portion provided in the flange portion and electrically connected with the positive electrode terminal, a second connection terminal portion provided in the flange portion and electrically connected with the negative electrode terminal, and a leaf spring portion electrically connected with at least one of the first connection terminal portion and the second connection terminal portion,
wherein at least one of electric connection between the first connection terminal portion and the first terminal of the surge absorption device and electric connection between the second connection terminal portion and the second terminal of the surge absorption device can be made through the leaf spring portion, and
wherein each of the respective electric connections can be maintained based on elastic force of the leaf spring portion.

14. The solenoid device according to claim 10,
wherein the flange portion has a flat portion extending in such a way as to be perpendicular to an axial direction and a cut-down surface that has been cut down from the flat portion toward the coil, and
wherein the first connection terminal portion and the second connection terminal portion are each arranged on the cut-down surface.

15. The solenoid device according to claim 11,
wherein the flange portion has a flat portion extending in such a way as to be perpendicular to an axial direction and a cut-down surface that has been cut down from the flat portion toward the coil, and
wherein the first connection terminal portion and the second connection terminal portion are each arranged on the cut-down surface.

16. The solenoid device according to claim 12,
wherein the flange portion has a flat portion extending in such a way as to be perpendicular to an axial direction and a cut-down surface that has been cut down from the flat portion toward the coil, and
wherein the first connection terminal portion and the second connection terminal portion are each arranged on the cut-down surface.

17. The solenoid device according to claim 13,
wherein the flange portion has a flat portion extending in such a way as to be perpendicular to an axial direction and a cut-down surface that has been cut down from the flat portion toward the coil, and
wherein the first connection terminal portion and the second connection terminal portion are each arranged on the cut-down surface.

18. The solenoid device according to claim 14,
wherein the positive electrode terminal has an extending portion that extends along the flat portion of the flange portion,
wherein the negative electrode terminal has an extending portion that extends along the flat portion of the flange portion,
wherein the first connection terminal portion is electrically connected with the extending portion of the positive electrode terminal, and
wherein the second connection terminal portion is electrically connected with the extending portion of the negative electrode terminal.

19. The solenoid device according to claim 15,
wherein the positive electrode terminal has an extending portion that extends along the flat portion of the flange portion,
wherein the negative electrode terminal has an extending portion that extends along the flat portion of the flange portion,
wherein the first connection terminal portion is electrically connected with the extending portion of the positive electrode terminal, and
wherein the second connection terminal portion is electrically connected with the extending portion of the negative electrode terminal.

20. The solenoid device according to claim 16,
wherein the positive electrode terminal has an extending portion that extends along the flat portion of the flange portion,
wherein the negative electrode terminal has an extending portion that extends along the flat portion of the flange portion,
wherein the first connection terminal portion is electrically connected with the extending portion of the positive electrode terminal, and
wherein the second connection terminal portion is electrically connected with the extending portion of the negative electrode terminal.

21. The solenoid device according to claim 17,
wherein the positive electrode terminal has an extending portion that extends along the flat portion of the flange portion,
wherein the negative electrode terminal has an extending portion that extends along the flat portion of the flange portion,
wherein the first connection terminal portion is electrically connected with the extending portion of the positive electrode terminal, and
wherein the second connection terminal portion is electrically connected with the extending portion of the negative electrode terminal.

22. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 9 is utilized.

23. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 10 is utilized.

24. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 11 is utilized.

25. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 12 is utilized.

26. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 13 is utilized.

27. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 14 is utilized.

28. A starter comprising:
a relay device that is driven by an engine starting signal so as to close a relay contact;
a solenoid device that has a coil to be energized by way of the relay contact when the relay device is driven and a solenoid switch that closes when the coil is energized;
a surge absorption device that absorbs a surge voltage generated in the coil; and
a motor that is driven so as to start an engine, when the solenoid switch closes, and
wherein as the solenoid device, the solenoid device according to claim 18 is utilized.
